(19) United States
(12) Patent Application Publication
(10) Pub. No.: US 2007/0109599 A1
(43) Pub. Date: May 17, 2007

(54) Method for producing a number of individual flip-books

(75) Inventors: Christoph Schacht, Berlin (DE); Christoph Chermont, Berlin (DE)

Correspondence Address: STETINA BRUNDA GARRED & BRUCKER, 75 ENTERPRISE, SUITE 250, ALISO VIEJO, CA, 92656, US

(73) Assignee: NEWSIGN WERBEAGENTUR GMBH

(21) Appl. No.: 11/273,174

(22) Filed: Nov. 14, 2005

(51) Int. Cl. G06K 15/00

(52) U.S. Cl. 358/1.18

(57) ABSTRACT

In the known methods, film images are printed, sorted and placed one on top of the other and bound. These methods are not suitable for inexpensively creating small or individual flip-books. In order to achieve this, according to the invention the film images are recorded by means of a digital system, transmitted to the manufacturer by means of remote data transmission and then standardized and printed out individually or with other orders. The flip-books are then formed in a conventional manner.

Method for producing a number of individual flip-books, wherein each flip-book is formed of a plurality of single images bound one behind the other for the purpose of being leafed through, comprising the method steps:
recording and storing a digital image sequence by means of a digital recording device,
transmitting the recorded image sequence to a computer,
printing out and arranging the film images in chronological order to form a stack of images, and
joining the stack of images together by binding the film images at one side to form a flip-book.

Flip-books were used in the early 1950s for visualizing film-like effects in a simple and inexpensive manner. These flip-books comprise single images which are bound at one side to form a block or a book and contain an image sequence so that a film effect is produced when the single images are leafed through.

As a result of modern media, flip-books have almost been forgotten nowadays since the original purpose of visually displaying small image sequences can now be achieved much better and more effectively by means of small playback devices.

USb 2002/0135808 A1 discloses a method of the type mentioned above for producing flip-books using a modern computer/printer assembly. In said document, an image sequence is obtained from a video film, this image sequence is then printed out and is subsequently bound in the form of a flip-book.

DE 197 30 495 A1 also discloses a method for producing a flip-book using modern computer technology. In said document, the user of the computer can print out the image sequence to be displayed onto a pre-perforated sheet using the installed software, and can then produce the flip-book by separating the perforations.

However, the two production methods mentioned above have the common disadvantage that production is possible only for an existing number of images on a local printer. However, the flip-book must be produced as professionally as possible, and this is not readily possible with the known methods since the complicated printing technology required for this is rarely profitable.

The object of the invention is therefore to provide an inexpensive method for creating, with high quality, an individually designed flip-book which is tailored to the demand of an individual customer.

According to the invention, this object is achieved by a method for producing a number of individual flip-books, which is characterized in that
the image sequence is transmitted to the computer by means of remote data transmission,
prior to printing out and arranging the film images, the image sequence is standardized to a predefined total number of images comprising a defined number of film images, wherein the standardization is carried out as a function of the change in the film images and the image frequency is reduced to 10 to 40 single images per second and then a number of flip-books are printed at the same time, wherein the method steps of recording and standardizing the image sequence are firstly carried out separately for each flip-book and then the film images of a number of flip-books are printed onto one or more common sheets, the film images are cut out and then are assigned to the various flip-books.

By virtue of the configuration of the method according to the invention, a flip-book is now combined with modern production technology. Essential to the invention is the fact that individual image sequences are recorded digitally, transmitted to the computer by means of remote data transmission and converted into the flip-book following standardization.

To this end, firstly an image sequence is recorded and then transmitted to the computer via remote data transmission, by means of which the flip-book is generated. The digital image sequence can be recorded either by means of digital cameras with corresponding generation of single images, but preferably use is made of a digital video camera which automatically generates the desired image sequence.

Flip-books preferably have an image density of approx. 60 film images. In the present application, the term “film image” means the image which is combined and bound as an image stack to form the flip-book.

By virtue of modern recording technology, the image frequency will usually be much higher than is required or desired for the flip-book. For example, a commercially available video camera will produce image frequencies of approx. 60 to 80 images per second, so that, for a desired stack height of at most 60 film images, the flip-book could display a film length of at most one second.

One feature of the invention therefore consists in the fact that the digitally recorded image sequence is firstly subjected to a standardization process. Depending on the total number of images which the flip-book is subsequently to contain, the recorded digital image sequence is firstly standardized. To this end, the image frequency is reduced to 10 to 40 single images, preferably 15 to 20 single images per second, so that the result is a film length of 4 to 5 seconds. For the limited optical display within the context of the flip-book, such an image frequency is sufficient to achieve the desired film effect.

The standardization of the image sequence is carried out by subjecting the image sequence to an analysis in order to reduce the density of the images. The analysis is carried out as a function of the change in the images. For example, it may be that approximately no changes are present in the image during the 1st second of a recorded film, while during the 2nd second for example a rapid succession of different images takes place as a result of increased movement in the scene. In the case of largely static scenes, the number of images can be considerably reduced provided that the associated shortening of the image sequence is also desired. Otherwise, the number of images must remain more or less the same here too, so that this film sequence is not shortened. Moreover, during the standardization, the corresponding number of images is removed from the image sequence, so that the desired total number of images is obtained.

The digital image sequence is transmitted to the computer by means of remote data transmission. A purchaser can then generate the digital image sequence himself and transmit it to the flip-book manufacturer. The latter then firstly arranges the images on a common sheet to be printed out, then prints the sheet out (preferably digitally), cuts the film images out of the printed sheet and sorts them to form the desired flip-book. After binding along one of the sides of the film images, the flip-book is then finished.

Preferably, the flip-book manufacturer will not produce just one flip-book but rather will produce lots of flip-books in parallel. To this end, he arranges a plurality of individual images on a sheet to be printed, said images belonging to different flip-books. Based on a preferred size of the film images of 11×6 cm, a plurality of images fit onto a commercially available A3 sheet, so that a number of flip-books can be produced with just one printing operation. If one sheet printing operation is not sufficient, further sheets can also be added. Following printing of the sheets, the film images are cut out and assigned to the individual flip-books. The flip-book can then be produced by binding in a manner which is already known.

Preferably, in the series production of flip-books, a large number of images is in each case assigned to one flip-book. For example, each printed sheet may contain sets of 10 film images. If the sheets comprise 10 rows of approximately 20 single images, 20 individual flip-books can be produced with these sheets if a total of 6 sheets are printed and the flip-books are to contain in each case 60 film images.

Of course, the aforementioned numbers of images and the alignment in rows of the film images belonging to a flip-book are given only by way of example. Any other thickness of flip-book can also be produced and the flip-books may also be arranged in rows on the sheet.

Further features and advantages of the invention emerge from the dependent claims.

1. Method for producing a number of individual flip-books, wherein each flip-book is formed of a plurality of single images bound one behind the other for the purpose of being leafed through, comprising the method steps:
recording and storing a digital image sequence by means of a digital recording device,
transmitting the recorded image sequence to a computer,
printing out and arranging the film images in chronological order to form a stack of images, and
joining the stack of images together by binding the film images at one side to form a flip-book,
characterized in that
the image sequence is transmitted to the computer by means of remote data transmission,
prior to printing out and arranging the film images, the image sequence is standardized to a predefined total number of images comprising a defined number of film images, wherein the standardization is carried out as a function of the change in the film images and the image frequency is reduced to 10 to 40 single images per second and
a number of flip-books are printed at the same time, wherein the method steps of recording and standardizing the image sequence are firstly carried out separately for each flip-book and then the film images of a number of flip-books are printed onto one or more common sheets, the film images are cut out and then are assigned to the various flip-books.

2. Method for producing a number of individual flip-books according to claim 1, characterized in that the image sequence is reduced to an image frequency of 15 to 20 single images as a result of the standardization.

3. Method for producing a number of individual flip-books according to claim 1, characterized in that a digital camera is used as the digital recording device.

4. Method for producing a number of individual flip-books according to one of the two preceding claims, characterized in that a digital video camera is used as the digital recording device.

5. Method for producing a number of individual flip-books according to one of the preceding claims, characterized in that there are 30 to 100 film images, preferably 60 film images, after the standardization.

6. Method for producing a number of individual flip-books according to one of the preceding claims, characterized in that the film images have a size of 12 cm×6 cm.
